(19) United States
(12) Patent Application Publication
(10) Pub. No.: US 2008/0052199 A1
(43) Pub. Date: Feb. 28, 2008

(54) COMPUTER SYSTEM AND METHOD FOR SELECTING APPLICABLE DOCUMENTS BASED ON DEPENDENCY TO PRODUCTS

(76) Inventors: Paula Rae Fulton, Rochester, MN (US); John Thomas Mowatt, Cedar Park, TX (US); Thomas Alan Shore, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/466,141

(22) Filed: Aug. 22, 2006

(51) Int. Cl. G06Q 10/00

(52) U.S. Cl. 705/28

(57) ABSTRACT

In an embodiment, inventories are received from clients, and the inventories identify products that are installed at the clients. In response to a request from a client, a document is selected based on a dependency indication. In an embodiment, the document is selected if the dependency indication indicates the document is dependent on a product and the product is installed at the client. In an embodiment, the document is selected if the dependency indication indicates the document is dependent on a product collection and one of the products in the collection is installed at the client. In an embodiment, the document is selected if the dependency indication indicates the document is dependent on the type of the client and independent of products that are installed at the client. The identifier and address of the selected document are added to a page, and the page is sent to the client.

### FIELD

An embodiment of the invention generally relates to computer systems and more specifically relates to selecting documents for clients based on dependency of the documents to products applicable to the clients.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Information is often stored at servers and sent to the clients in units of pages. One type of information that servers provide to clients is technical support information relating to hardware and software products that may be installed at the client. An example of providing support information is manufacturers and sellers of computer systems, hardware, and/or software products that utilize servers to provide documentation and problem diagnosis and resolution services to their customers. Often, these servers host a great deal of information for a wide range of topics and for a great many products, which causes the user at the client difficulty when attempting to find the desired information on the desired topic for the desired product.

A current technique for assisting the user is a database at the server that allows the user at the client to enter search keywords and search for the desired information. This technique suffers from the problem that the user might not know the keywords that will yield the most helpful information. For example, if the user is searching for instructions on how to clear a printer jam, the user might choose the search keywords “clear printer jam,” which yields search results for a variety of printers, each having different instructions for clearing a jam. Thus, the search results are not tailored for the printer that the user owns, which causes the user to expend additional time reading the search results. Another current technique is for the server to append additional keywords that describe the user's products to the search keywords submitted by the user. This technique suffers from the problem that these additional keywords may be too restrictive, i.e., they may not be present in the most relevant document. For example, if the user needs instructions on how to install a new printer driver, and the server appends an additional keyword that describes the model number of the user's computer, this keyword may not be present in the desired document because the desired instructions apply to all computer model numbers.

Thus, a better technique is needed for tailoring the navigation of relevant documentation to the user. Although the aforementioned problems have been described in the context of support information, they may occur in any document selection context.

### SUMMARY

A method, apparatus, system, and signal-bearing medium are provided. In an embodiment, inventories are received from clients, and the inventories identify products that are installed at the clients. In response to a request from a client, a document is selected based on a dependency indication. In an embodiment, the document is selected if the dependency indication indicates the document is dependent on a product and the product is installed at the client. In an embodiment, the document is selected if the dependency indication indicates the document is dependent on a product collection and one of the products in the collection is installed at the client. In an embodiment, the document is selected if the dependency indication indicates the document is dependent on the type of the client and independent of products that are installed at the client. The identifier and address of the selected document are added to a page, and the page is sent to the client where it may be viewed. In this way, documents may be tailored to installed products at the client.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example data structure for inventory data, according to an embodiment of the invention.

FIG. 3 depicts a block diagram an example data structure for link data, according to an embodiment of the invention.

FIG. 4 depicts a block diagram of an example data structure for inventory dependency token data, according to an embodiment of the invention.

FIG. 5A depicts a block diagram of an example data structure for validated dependency data, according to an embodiment of the invention.

FIG. 5B depicts a block diagram of an example data structure for validated dependency data for an example client, according to an embodiment of the invention.

FIG. 6 depicts a block diagram of example documents, according to an embodiment of the invention.

FIG. 7 depicts a block diagram of an example navigation page, according to an embodiment of the invention.

FIG. 8 depicts a flowchart of example processing for adding a new document, according to an embodiment of the invention.

FIG. 9 depicts a flowchart of example processing for setting an inventory dependency indication, according to an embodiment of the invention.

FIG. 10 depicts a flowchart of example processing for receiving inventory data from clients, according to an embodiment of the invention.

FIG. 11 depicts a flowchart of example processing for creating a navigation page for a client, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a server sets dependency indications for documents. A dependency indication indicates a relationship of the respective document to products and to types of clients at which the products may be installed. In an embodiment, the dependency indication indicates the document is dependent on an identified product. Being dependent on an identified product means that in order for a page with a link to the document to be sent to the client, the identified product must be installed at the client. In another embodiment, the dependency indication indicates that the document is dependent on a product collection to which multiple products belong. Being dependent on the product collection means that in order for a page with a link (including an identifier and address) to the document to be sent to the client, at least one of the products that belongs to the product collection must be installed at the client. In another embodiment, the dependency indication indicates the document is dependent on an identified type of the client, but is independent of whatever products may be installed at the client having that type. Being dependent on a client type means that in order for a page with link to the document to be sent to a client, the client must have the identified type, regardless of what products are installed at the client (if any).

The server receives inventories from clients, and the inventories identify the products that are installed at the respective clients. In response to a request from a client, documents are selected based on the document's dependency indication, the client's type, and/or the products that are installed at the client. In an embodiment, the document is selected if its dependency indication indicates the document is dependent on a product and the product is installed at the client. In another embodiment, the document is selected if its dependency indication indicates the document is dependent on a product collection and at least one of the products in the collection is installed at the client. In another embodiment, the document is selected if its dependency indication indicates the document is dependent on the type of the client and the client has that type installed at the client. The identifier and address of the selected documents are added to a page, and the page is sent to the client.

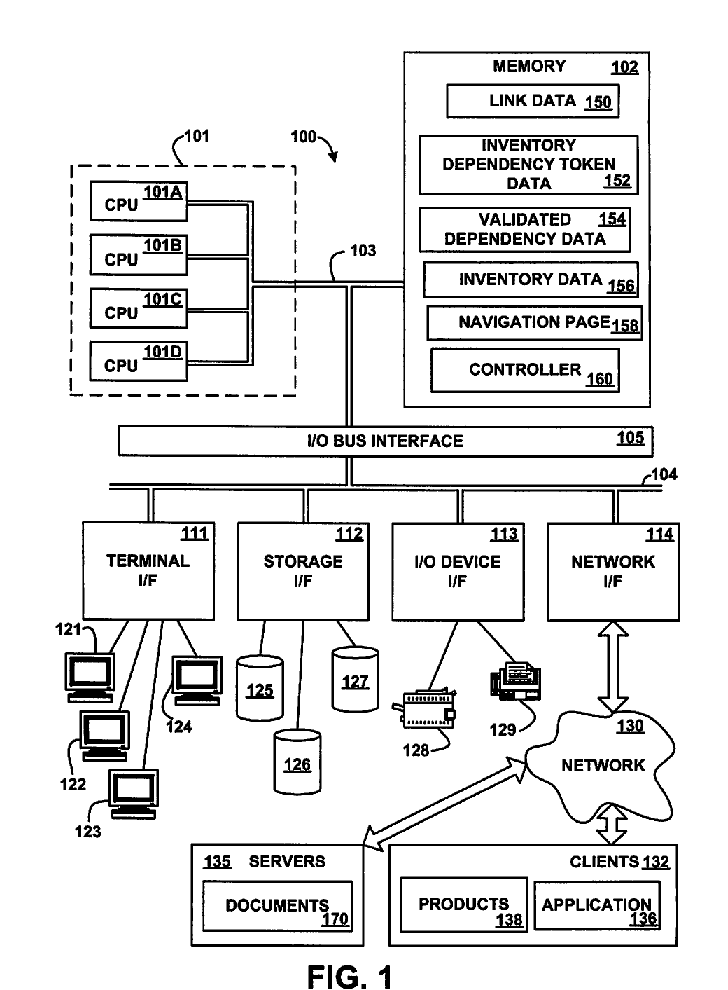

Referring to the Drawings, wherein like numbers denote like parts throughout the several views, FIG. 1 depicts a high-level block diagram representation of a server computer system 100 connected to client computer systems 132 and server computer systems 135 via a network 130, according to an embodiment of the present invention. The terms “client” and “server” are used herein for convenience only, and in various embodiments a computer that operates as a client in one environment may operate as a server in another environment, and vice versa. In an exemplary embodiment, the hardware components of the computer systems 100, 132, and 135 may be implemented by an eServer iSeries computer system available from International Business Machines Corporation of Armonk, N.Y. However, those skilled in the art will appreciate that the mechanisms and apparatus of embodiments of the present invention apply equally to any appropriate computing system.

The major components of the server computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The server computer system 100 contains one or more general-purpose programmable central processing units (CPUs) 101A, 101B, 101C, and 101D, herein generically referred to as the processor 101. In an embodiment, the server computer system 100 contains multiple processors typical of a relatively large system; however, in another embodiment the server computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the server computer system 100, and may also include the virtual memory of other computer systems coupled to the server computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes link data 150, inventory dependency token data 152, validated dependency data 154, inventory data 156, a navigation page 158, and a controller 160. Although the link data 150, the inventory dependency token data 152, the validated dependency data 154, the inventory data 156, the navigation page 158, and the controller 160 are illustrated as being contained within the memory 102 in the server computer system 100, in other embodiments some or all of them may be on different computer systems and may be accessed remotely, e.g., via the network 130. The server computer system 100 may use virtual addressing mechanisms that allow the programs of the server computer system 100 to behave as if they only have access to a large, single storage entity instead of access to multiple, smaller storage entities. Thus, while the link data 150, the inventory dependency token data 152, the validated dependency data 154, the inventory data 156, the navigation page 158, and the controller 160 are illustrated as being contained within the main memory 102, these elements are not necessarily all completely contained in the same storage device at the same time. Further, although the link data 150, the inventory dependency token data 152, the validated dependency data 154, the inventory data 156, the navigation page 158, and the controller 160 are illustrated as being separate entities, in other embodiments some of them, portions of some of them, or all of them may be packaged together.

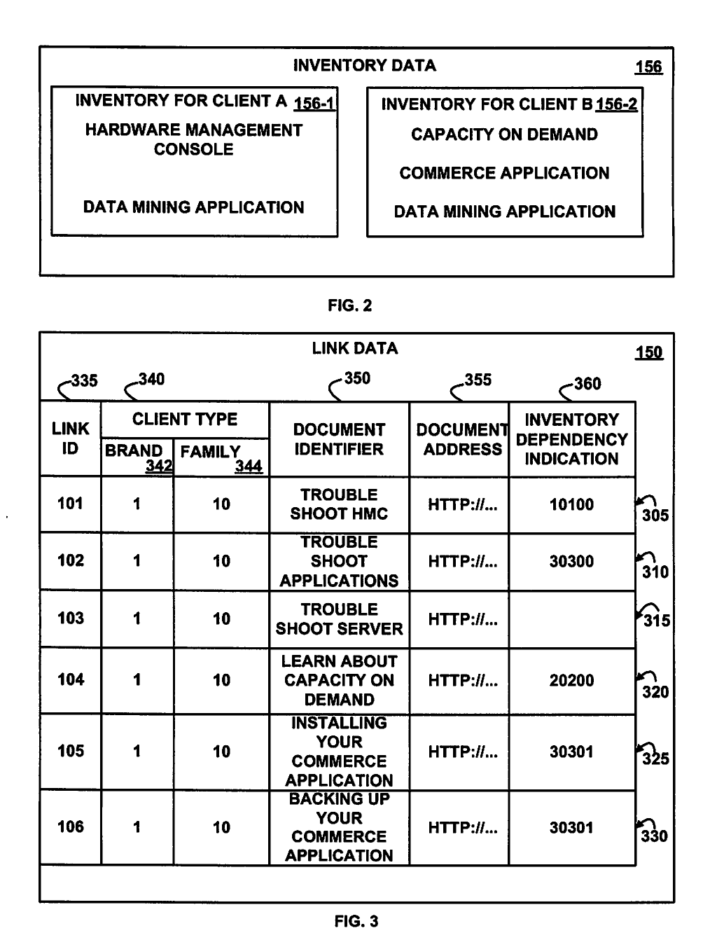

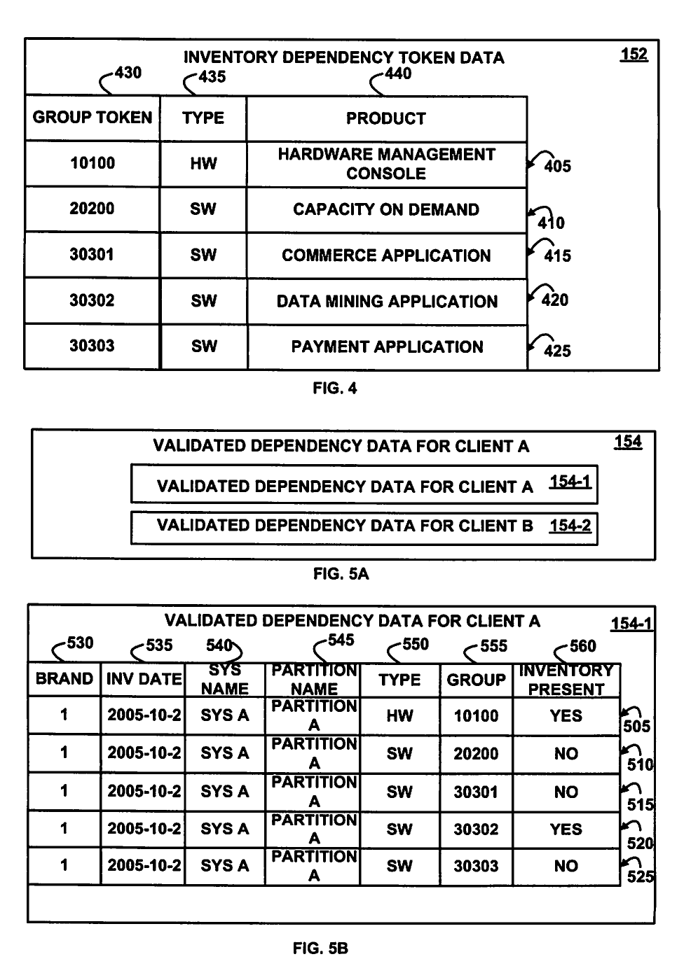

The link data 150 describes the dependencies of the documents to products that may be installed at the clients. The link data 150 is further described below with reference to FIG. 3. The inventory dependency token data 152 represents all of the possible products supported by the server computer system 100 that may be installed at the client computer systems 132. The inventory dependency token data 152 is further described below with reference to FIG. 4. The validated dependency data 154 indicates whether products are installed at the client computer system 132. The validated dependency data 154 is further described below with reference to FIGS. 5A and 5B. The inventory data 156 represents the inventory of the products 138 that have been reported as being installed at the client computer systems 132. The inventory data 156 is further described below with reference to FIG. 2. The navigation page 158 includes links for documents that the controller 160 has selected as relevant to a client computer system 132. The navigation page 158 is further described below with reference to FIG. 7.

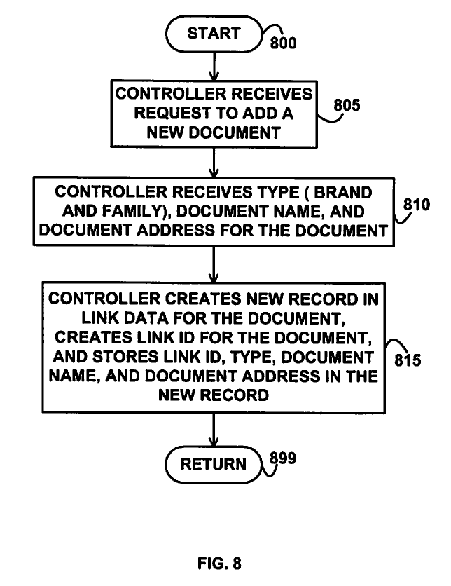

In an embodiment, the controller 160 includes instructions capable of executing on the processor 101 or statements capable of being interpreted by instructions executing on the processor 101 to perform the functions as further described below with reference to FIGS. 8, 9, 10, and 11. In another embodiment, the controller 160 may be implemented in microcode. In another embodiment, the controller 160 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the server computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the server computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The server computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The server computer system 100 may alternatively be a single-user system, typically containing only a single user display and keyboard input, or might be a server or similar device which has little or no direct user interface, but receives requests from other computer systems (clients). In other embodiments, the server computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the server computer system 100, the client computer systems 132, and the server computer systems 135. In various embodiments, the network 130 may represent a storage device or a combination of storage devices, either connected directly or indirectly to the server computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client computer systems 132 may include some or all of the hardware components previously described above as being included in the server computer system 100. The client computer systems 132 include an application 136 and products 138. The application 136 sends inventory data 156 to the server computer system 100 and receives and displays or presents the navigation page 158. The application 136 may be implemented via a browser, an operating system, a user application, a third-party application, or any appropriate program encoded with executable instructions or interpretable statements for execution on a processor with a description similar to the processor 101. In another embodiment, the application 136 may implemented in hardware. The products 138 may be any hardware and/or software encoded in memory analogous to the memory 102. The products 138 are installed at the client computer systems 132, which means that they are connected electrically and/or mechanically to the client computer systems 132. The products 138 may be, but are not necessarily, operational.

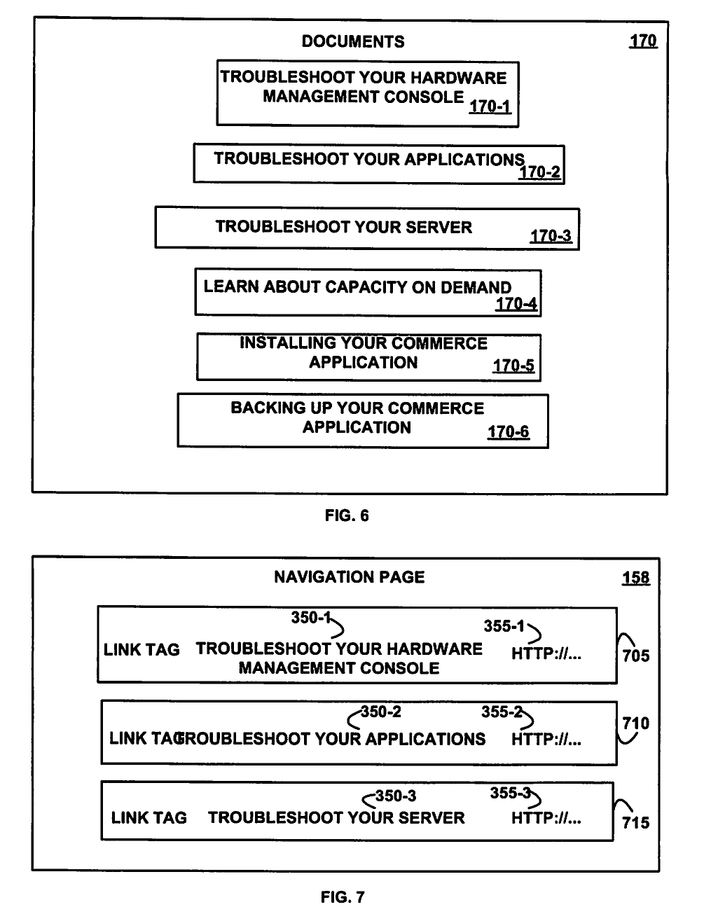

The server computer systems 135 may include some or all of the hardware components previously described above as being included in the server computer system 100. The servers 135 include documents 170 stored in memory with a similar description as the main memory 102. The documents 170 may include any appropriate content, such as tutorials, help information, tips, techniques, installation information, problem diagnosis and resolution information, service information, or any other appropriate information. In various embodiments, the documents 170 may be implemented via documents, files, objects, tables, databases, directories, subdirectories, or any portion or combination thereof and in some embodiments may include embedded control tags, statements, or logic instructions or statements in addition to, or in lieu of data. The documents 170 are further described below with reference to FIG. 6.

It should be understood that FIG. 1 is intended to depict the representative major components of the server computer system 100, the network 130, the client computer systems 132, and the server computer systems 135 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the server computer system 100 and/or the client computer system 132, and that, when read and executed by one or more processors in the server computer system 100 and/or the client computer system 132, cause the server computer system 100 and/or the client computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server computer system 100 and/or the client computer system 132 via a variety of tangible signal-bearing media that may be operatively or communicatively connected (directly or indirectly) to the processor or processors, such as the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102, CD-RW, or diskette; or

(3) information conveyed to the server computer system 100 and/or the client computer system 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for the inventory data 156, according to an embodiment of the invention. The inventory data 156 includes example inventories for a variety of client computer systems 132 including an inventory 156-1 for the client A and an inventory 156-2 for the client B, each of which identifies a product or products 138 that are installed at the respective client computer system 132. The products 138 installed at each client computer system 132 are a subset of the possible products 138 that are identified in the inventory dependency token data 152. The client computer system 132 identified as the “client A” reported the inventory 156-1, and the client identified as the “client B” reported the inventory 156-2 to the server computer system 100.

FIG. 3 depicts a block diagram an example data structure for the link data 150, according to an embodiment of the invention. The link data 150 includes example records 305, 310, 315, 320, 325, and 330, each of which includes a link identifier field 335, a client type field 340, a document identifier field 350, a document address field 355, and an inventory dependency indication field 360, but in other embodiments more or fewer fields may be present. Each of the records 305, 310, 315, 320, 325, and 330 represents one of the documents 170. The link identifier field 335 identifies the record in the link data 150. The client type field 340 identifies a type of the client computer system 132 and, in an embodiment, includes a brand field 342 and a family field 344. The brand field 342 identifies a source or provider of the client, such as a manufacturer or seller of the client. The family 344 further distinguishes the client type within the brand 342 and may identify a category and optional subcategories to which the client belongs, such as a printer, desktop, or server and a model number.

The document identifier field 350 uniquely identifies a document 170; in various embodiments, the document identifier 350 may be a name, a title, an abstract, a numerical identifier, an alphanumeric identifier, or any other appropriate technique for identifying the document 170. The document address field 355 indicates the address or location of the document 350 from which the document 350 may be retrieved. In an embodiment, the document address 355 may be a URL (Uniform Resource Locator) or other address of the document at the server computer system 135.

The inventory dependency indication field 360 indicates a relationship of the document to the products 138 and to types of the client computer systems 132. In an embodiment, the inventory dependency indication field 360 indicates the document 170 (with the document identifier 350 and the document address 355) is dependent on the product 138 that is identified in the inventory dependency field 360. Examples of a document 170 being dependent on a product 138 are illustrated in records 305, 320, 325, and 330. Being dependent on the identified product means that in order for a link (including the document identifier 350 and the document address 355) of the document 170 to be sent to a client computer system 132 of the client type 340, the product 138 identified by the inventory dependency indication 360 must be installed at that client computer system 132.

In another embodiment, the inventory dependency indication 360 indicates the document 170 is dependent on a product collection that identifies multiple products, and the product collection is a subset of all of the possible products 138. An example of a document 170 being dependent on a product collection is illustrated in record 310. The inventory dependency indication 360 of the record 310 uses the convention that any product whose token falls within “303001” to “30399” belongs to the product collection whose token is “30300,” but in other embodiments any appropriate convention may be used for identifying a product collection and products that belong to the product collection. For example, in other embodiments, the controller 160 may use the token of the product collection as an index to find a row or record of products that belong to the product collection, or the token of the product collection may point to or identify the tokens that identify the products that belong to the product collection. Being dependent on the product collection that is identified in the inventory dependency indication field 360 means that in order for a link to the document 170 to be sent to the client computer system 132, at least one of the products 138 that belongs to the product collection must be installed at the client computer system 132.

In another embodiment, the inventory dependency indication field 360 indicates that the document 170 is dependent on the type 340 of the client computer system 132, but is independent of whatever products 138 may be installed at the client computer system 132. An example of a document 170 being dependent on a client type 340 is illustrated by record 315, which has no product identified in the inventory dependency indication 360. Being dependent on a client type 340 means that in order for a link to the document 170 to be sent to the client computer system 132, the client computer system 132 must have the client type 340, regardless of what products 138 are installed at the client computer system 132 (if any).

FIG. 4 depicts a block diagram of an example data structure for the inventory dependency token data 152, according to an embodiment of the invention. The inventory dependency token data 152 represents all of the possible products 138 that may be installed at a client computer system 132. The inventory dependency token data 152 includes example records 405, 410, 415, 420, and 425, each of which includes an example group token field 430, a type field 435, and a product field 440. The group token field 430 identifies the product 440. The group tokens 430 in the records 415, 420, and 420 identify products 138 that belong to the product collection that is identified in the inventory dependency indication field 360 in the record 310 of the link data 150 (FIG. 3). The type field 435 indicates whether the product 440 is hardware or software. The product field 440 describes the respective product 138.

FIG. 5A depicts a block diagram of an example data structure for the validated dependency data 154, according to an embodiment of the invention. The validated dependency data 154 includes data for each of the client computer systems 132 that has reported inventory to the server computer system 100, such as the validated dependency data 154-1 and 154-2.

FIG. 5B depicts a block diagram of an example data structure for validated dependency data 154-1 for an example client computer system 132, according to an embodiment of the invention. The validated dependency data 154-1 includes example records 505, 510, 515, 520, and 525, each of which includes a brand field 530, an inventory date field 535, a system name field 540, a partition name field 545, a type field 555, a group token field 555, and an inventory present field 560, but in other embodiments more or fewer fields may be present. The brand field 530 identifies a manufacturer of the product that is identified by the group token 555. The inventory date field 535 identifies the time and/or date at which the server computer system 100 received the inventory data 156 from the client computer system 132 associated with the validated dependency data 154-1. The system name field 540 indicates a name of the client computer system 132. The partition name field 545 identifies an operating system partition that executes at the client computer system 132 that is associated with the product identified by the group token 555. The type field 555 identifies whether the product identified by the group token 555 is hardware or software. The group token field 555 identifies the product associated with the record. The valid values for the group token field 555 are illustrated in the group token field 430, as previously described above with reference to FIG. 4. The inventory present field 560 indicates whether the product 138 identified by the group token 555 is installed at the client computer system 132 that is associated with the validated dependency data 154-1, as reported by the client computer system 132 via the inventory data 156.

FIG. 6 depicts a block diagram of example documents 170, according to an embodiment of the invention. The documents 170 may include any appropriate content, such as tutorials, help information, tips, techniques, installation information, problem diagnosis and resolution information, service information, or any other appropriate information. In various embodiments, the documents 170 may be implemented via documents, files, objects, tables, databases, directories, subdirectories, or any portion or combination thereof and in some embodiments may include embedded control tags, statements, or logic instructions or statements in addition to or in lieu of data. The documents 170 include a variety of example documents 170-1, 170-2, 170-3, 170-4, 170-5 and 170-6. The document 170-1 is associated with the record 305 of the link data 150, the document 170-2 is associated with the record 310, the document 170-3 is associated with the record 315, the document 170-4 is associated with the record 320, the document 170-5 is associated with the record 325, and the document 170-6 is associated with the record 330.

FIG. 7 depicts a block diagram of an example navigation page 158, according to an embodiment of the invention. The navigation page 158 includes link tags 705, 710, and 715, which include respective embedded document identifiers 350-1, 350-2, and 350-3 and respective document addresses 355-1, 355-2, and 355-3. The document identifiers 350-1, 350-2, and 350-3 identify or describe the respective documents 170-1, 170-2, and 170-3. The document addresses 355-1, 355-2, and 355-3 indicate the location or address of the respective documents 170-1, 170-2, and 170-3 at the server computer systems 135. The controller 160 selects the documents 170-1, 170-2, and 170-3, adds their document identifiers 350 to the navigation page 158 as the document identifiers 350-1, 350-2, and 350-3, adds their document addresses 355 to the navigation page 158 as the document addresses 355-1, 355-2, and 355-3, and sends the navigation page 158 to the client computer system 132. The application 136 at the client computer system 132 interprets the link tags 705, 710, and 715 and displays the identifiers 350-1, 350-2, and 350-3 as links on a terminal analogous to the terminal 121, 122, 123, or 124. In response to selection of a displayed link, e.g., via a user interface, the application 136 uses the address 355-1, 355-2, or 355-3 to retrieve the associated document 170-1, 170-2, or 170-3 from the server computer system 135.

FIG. 8 depicts a flowchart of example processing for adding a new document, according to an embodiment of the invention. Control begins at block 800. Control then continues to block 805 where the controller 160 receives a request to add a new document to the documents 170, e.g., via a user interface at one of the terminals 121, 122, 123, or 124. Control then continues to block 810 where the controller 160 receives the client type (e.g., a brand and family), a document identifier, and document address for the new document. Control then continues to block 815 where the controller 160 creates a new record in the link data 150 for the new document, creates a link identifier 335 for the new document, and stores the link identifier 335, the client type 340, the document identifier 350, and the document address 355 in the record. Control then continues to block 899 where the logic of FIG. 8 returns.

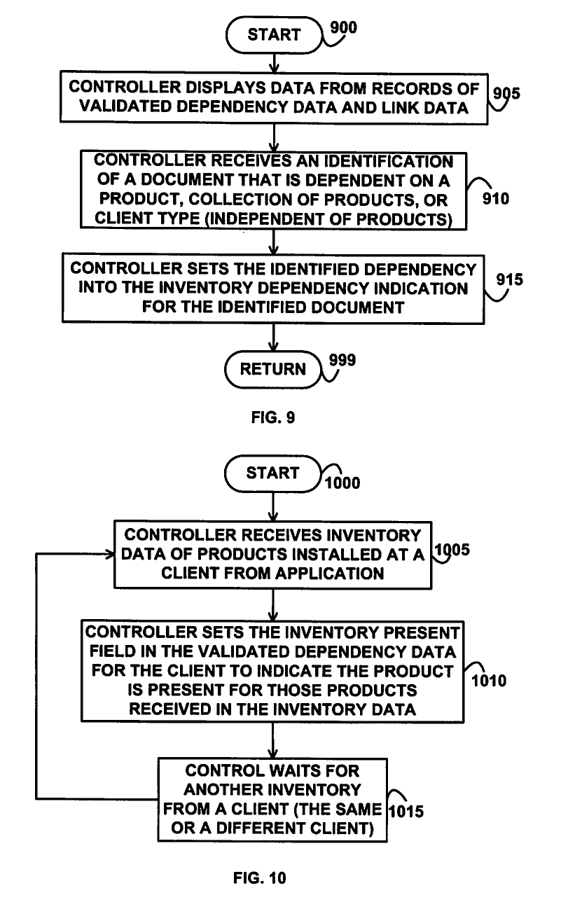

FIG. 9 depicts a flowchart of example processing for setting an inventory dependency indication 360, according to an embodiment of the invention. Control begins at block 900. Control then continues to block 905 where the controller 160 displays data from the records of the validated dependency data 154 and the link data 150. Control then continue to block 910 where the controller 160 receives an identification of a document 170 that is dependent on a product, dependent on a collection of the products 138, or dependent on a client type 340 (independent of the products 138). Control then continue to block 915 where the controller 160 sets the identified dependency into the inventory dependency indication 360 for the identified document 170. Control then continues to block 999 where the logic of FIG. 9 returns. In another embodiment, the logic of FIG. 9 may be combined with the logic of FIG. 8.

FIG. 10 depicts a flowchart of example processing for receiving the inventory data 156, according to an embodiment of the invention. Control begins at block 1000. Control then continues to block 1005 where the controller 160 receives the inventory data 156 of the products 138 that are installed at the client computer system 132 from the application 136. In an embodiment, the application 136 initially sends its entire inventory 156 of products 138 at the client computer system 132 to the controller 160, and subsequently the application 136 resends the inventory 156 or selected portions of its inventory 156 if the installed products 138 change, such as if a new installed product 138 is added or an existing installed product is deleted at the client computer system 132. In various embodiments, the application 136 may send the inventory in real time in response to changes to the inventory or may periodically send the inventory on a scheduled basis to the controller 160.

Control then continues to block 1010 where the controller 160 sets the inventory present field 560 in the validated dependency data 154 for the client computer system 132 that send its inventory to indicate that the product is installed for those products 138 that are in the received inventory data 156. In various embodiments, the controller 160 may perform the processing of block 1010 in response to receipt of the inventory from the application 136, may store the inventory for later processing, and/or may accumulate inventories from multiple clients before processing the validated dependency data. Control then continues to block 1015 where the controller 160 waits for another inventory, which may be for the same or a different client computer system 132. Control then returns to block 1005, as previously described above.

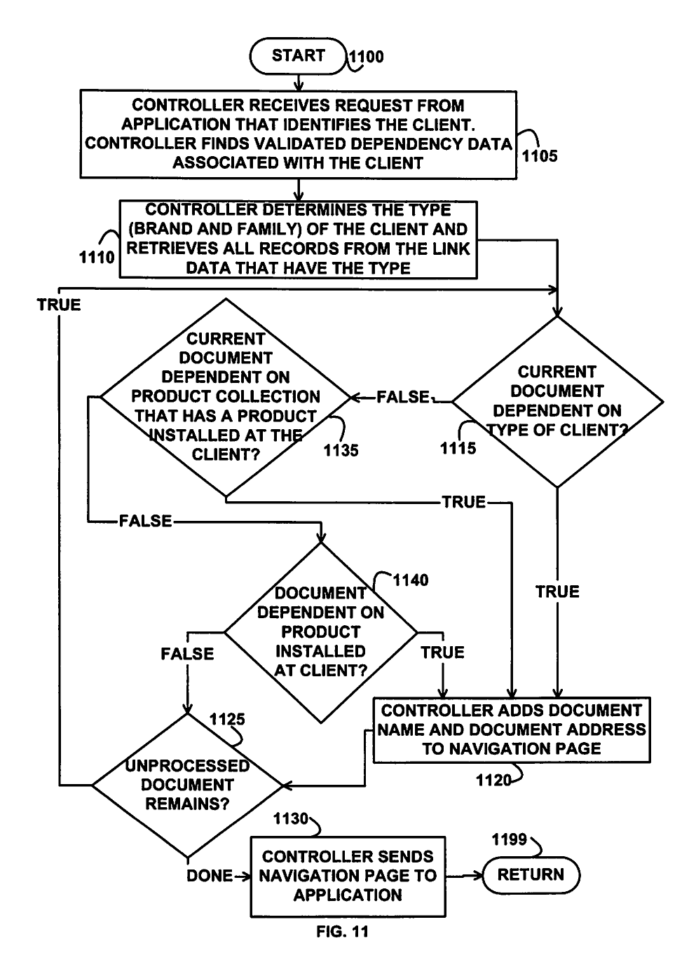

FIG. 11 depicts a flowchart of example processing for creating a navigation page 158 for a client computer system 132, according to an embodiment of the invention. Control begins at block 1100. Control then continues to block 1105 where the controller 160 receives a request from the application 136 that identifies the client computer system 132. In various embodiments, the request may be a login request, a request for help, service, installation, problem determination, or support information, or any other type of request. The controller 160 further finds the validated dependency data 154 associated with the client computer system 132. Control then continues to block 1110 where the controller 160 determines the client type 340 (e.g., the brand 342 and family 344) of the client computer system 132 and retrieves a subset of the records from the link data 150 that have the determined client type 340 of the client computer system 132.

Control then determines to block 1115 where the controller 160 enters a loop that is executed once for each document 170 in the subset of the link data 150. The current document, as used herein, is the document 170 associated with the current record in the subset of the link data 150 that the controller 160 is processing during the current iteration of the loop. The controller 160 determines whether the current document 170 of the current record in the subset of the link data 150 is dependent on the client type 340 of the client computer system 132 that sent the request. In an embodiment, the controller 160 makes the determination of block 1115 by determining whether the inventory dependency indication 360 for the current record in the subset of the link data 150 associated with the current document 170 is lacking a group token.

If the inventory dependency indication 360 for the current record in the subset of the link data 150 associated with the current document 170 is dependent on the client type 340, then the current document 170 is independent of any products 138, regardless of whether the products 138 are installed at the client computer system 132, so the current document 170 is applicable to, and is dependent on, a client computer system 132 that has the client type 340 of the record. An example of a record in the data that represents a document 170 that is dependent on a client type 340 is the record 315. If the determination at block 1115 is true, then the current document 170 is dependent on the type 340 of the client computer system 132, so control continues to block 1120 where the controller 160 adds the current document identifier 350 and the current document address 355 to the navigation page 158.

Control then continues to block 1125 where the controller 160 determines whether a next document 170 exists with a record in the subset of the link data 150 that has not yet been processed by the loop that starts at block 1115. If the determination at block 1125 is true, then a next document 170 exists that has not yet been processed, so the controller 160 sets the current document 170 to be the next document 170 and returns to block 1115, as previously described above.

If the determination at block 1125 is false, then all of the documents 170 represented in the subset of the link data 150 have been processed by the loop that starts at block 1115, so control continues from block 1125 to block 1130 where the controller 160 sends the navigation page 158 to the application 136 at the client computer system 132 that sent the request. The application 136 receives the navigation page 158, renders the information, displays the information, and retrieves any document or documents 170 selected via the links 705, 710, or 715. Control then continues to block 1199 where the logic of FIG. 11 returns.

If the determination at block 1115 is false, then the current document is not dependent on the client type 340 of the client computer system 132, so control continues to block 1135 where the controller 160 determines whether the current document 170 is dependent on a product collection and at least one product that belongs to the collection is installed at the client computer system 132 that sent the request. The controller 160 makes the determination of block 1135 by determining if the inventory dependency indication 360 in the current record of the subset of the link data 150 associated with the current document 170 indicates a group token that identifies a collection of the products 138 and at least one of the products 138 that belongs to the product collection has an associated group token that exists in a record of the validated dependency data 154-1 for the client computer system 132 that has the inventory present field 560 set to indicate that the at least one product that belongs to the collection is installed at the client computer system 132. An example of a document 170 that is dependent on a product collection is the document 170 represented by the record 310, which is dependent on the group token “30300,” which represents a product collection to which the products 138 represented by the tokens “30301,” “30302,” and “30303” belong. One of the products 138 that belongs to the product collection is installed at the client computer system 132, as indicated by the record 520 in the validated group dependency data 154-1, which shows the group 555 having a token of “30302” with the inventory present 560 set to indicate that the product represented by “30302” is installed at the client computer system 132.

If the determination at block 1135 is true, then the current document 170 is dependent on a product collection with at least one product that belongs to the product collection installed at the client computer system 132, so control continues to block 1120 where the controller 160 adds the document identifier 350 and document address 355 of the current document to the navigation page 158. Control then continues to block 1125, as previously described above.

If the determination at block 1135 is false, then the current document 170 is not dependent on a product collection that has a product installed at the client computer system 132, so control continues to block 1140 where the controller 160 determines whether the current document 170 is dependent on a product 138 that is installed at the client computer system 132. The controller 160 makes the determination of block 1140 by determining if the inventory dependency indication 360 in the current record of the subset of the link data 150 associated with the current document 170 indicates a group token and that group token exists in a record of the validated dependency data 154-1 for the client computer system 132 that has the inventory present field 560 set to indicate that the product 138 identified by the group token is installed at the client computer system 132. If the determination at block 1140 is true, then the current document 170 is dependent on a product that is installed at the client computer system 132 that sent the request, so control continues to block 1120, as previously described above.

If the determination at block 1140 is false, then the current document 170 is not dependent on a product that is installed at the client computer system 132, so control continues to block 1125, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
for each of a plurality of documents, setting a respective dependency indication;
receiving a plurality of inventories from a plurality of clients, wherein each of the inventories identifies a subset of a plurality of products that is installed at the respective client;
in response to a request from one of the clients, selecting a first document from the plurality of documents with the respective dependency indication that indicates the first document is dependent on one of the products that is installed at the one client;
adding a first identifier and a first address of the first document to a page; and
sending the page to the one client.

2. The method of claim 1, further comprising:
selecting a second document from the plurality of documents with the respective dependency indication that indicates the second document is dependent on a product collection that identifies a subset of the plurality of products, wherein one of the products in the product collection is installed at the one client; and
adding a second identifier and a second address of the second document to the page.

3. The method of claim 1, further comprising:
determining a type of the one client.

4. The method of claim 3, further comprising:
selecting a third document from the plurality of documents with the respective dependency indication that indicates the third document is dependent on the type of the one client; and
adding a third identifier and a third address of the third document to the page.

5. The method of claim 3, wherein the selecting further comprises:
finding a subset of the plurality of documents that are applicable to the type of the one client; and
selecting the first document from the subset.

6. The method of claim 1, wherein the setting the respective dependency indication further comprises:
setting the respective dependency indication to indicate the respective document is dependent on whether one of the plurality of products is installed.

7. The method of claim 1, wherein the setting the respective dependency indication further comprises:
setting the respective dependency indication to indicate the respective document is dependent on whether a product collection of a subset of the plurality of products is installed.

8. The method of claim 1, wherein the setting the respective dependency indication further comprises:
setting the respective dependency indication to indicate the respective document is independent of whether the plurality of products are installed.

9. A method for deploying computing services, comprising:
integrating computer readable code into a computer system, wherein the code in combination with the computer system performs the method of claim 1.

10. A signal-bearing medium encoded with instructions, wherein the instructions when executed comprise:
for each of a plurality of documents, setting a respective dependency indication;
receiving a plurality of inventories from a plurality of clients, wherein each of the inventories identifies a subset of a plurality of products that is installed at the respective client;
receiving a request from one of the clients;
determining a type of the one client;
selecting a first document from the plurality of documents with the respective dependency indication that indicates the first document is dependent on one of the products that is installed at the one client, wherein the selecting further comprises finding a first subset of the plurality of documents that are applicable to the type of the one client and selecting the first document from the first subset;
adding a first identifier and a first address of the first document to a page; and
sending the page to the one client.

11. The signal-bearing medium of claim 10, further comprising:
selecting a second document from the plurality of documents with the respective dependency indication that indicates the second document is dependent on a product collection that identifies a second subset of the plurality of products, wherein one of the products in the product collection is installed at the one client; and
adding a second identifier and a second address of the second document to the page.

12. The signal-bearing medium of claim 10, further comprising:
selecting a third document from the plurality of documents with the respective dependency indication that indicates the third document is dependent on the type of the one client; and
adding a third identifier and a third address of the third document to the page.

13. The signal-bearing medium of claim 10, wherein the setting the respective dependency indication further comprises:
setting the respective dependency indication to indicate a relationship of the respective document to the products.

14. The signal-bearing medium of claim 10, wherein the setting the respective dependency indication further comprises:
setting the respective dependency indication to indicate the respective document is dependent on whether one of the plurality of products is installed.

15. The signal-bearing medium of claim 10, wherein the setting the respective dependency indication further comprises:
setting the respective dependency indication to indicate the respective document is dependent on whether a product collection is installed.

16. The signal-bearing medium of claim 10, wherein the setting the respective dependency indication further comprises:
setting the respective dependency indication to indicate the respective document is independent of whether the plurality of products are installed.

17. A computer system comprising:
a processor; and
memory connected to the processor, wherein the memory is encoded with instructions that, when executed on the processor, comprise:
for each of a plurality of documents, setting a respective dependency indication to indicate a relationship of the respective document to a plurality of products,
receiving a plurality of inventories from a plurality of clients, wherein each of the inventories identifies a subset of the plurality of products that is installed at the respective client,
receiving a request from one of the clients,
determining a type of the one client;
selecting a first document from the plurality of documents with the respective dependency indication that indicates the first document is dependent on one of the products that is installed at the one client, wherein the selecting further comprises finding a first subset of the plurality of documents that are applicable to the type of the one client and selecting the first document from the first subset,
adding a first identifier and a first address of the first document to a page, and
sending the page to the one client.

18. The computer system of claim 17, wherein the instructions further comprise:
selecting a second document from the plurality of documents with the respective dependency indication that indicates the second document is dependent on a product collection that identifies a second subset of the plurality of products, wherein one of the products in the product collection is installed at the one client;
adding a second identifier and a second address of the second document to the page;
selecting a third document from the plurality of documents with the respective dependency indication that indicates the third document is dependent on the type of the one client; and
adding a third identifier and a third address of the third document to the page.

19. The computer system of claim 17, wherein the setting the respective dependency indication further comprises:
setting the respective dependency indication to indicate the respective document is dependent on whether one of the plurality of products is installed.

20. The computer system of claim 17, wherein the setting the respective dependency indication further comprises:
setting the respective dependency indication to indicate the respective document is dependent on whether a product collection is installed.
